(19) United States
(12) Patent Application Publication
(10) Pub. No.: US 2006/0031926 A1
(43) Pub. Date: Feb. 9, 2006

(54) Method for reduced signon, using password synchronization instead of a credential database and scripts

(76) Inventor: Idan Shoham, Calgary (CA)

Correspondence Address: Idan Shoham, 500, 1401 1st Street SE, Calgary, AB, T2G 2J3, CA

(21) Appl. No.: 10/909,955

(22) Filed: Aug. 3, 2004

(51) Int. Cl. G06F 17/30

(52) U.S. Cl. 726/8

(57) ABSTRACT

A method for reducing the number of times that a user must type his own login ID or password into various systems that require authentication is disclosed. The method comprises the steps of: 1. A user signs into his workstation, using a standard login ID and current network password. 2. A plugin program, inserted into the workstation operating system's login subsystem, captures the user's login ID and password. 3. In environments where this is either not technically possible or where insertion of such a plugin program is infeasible, once the user has completed the initial workstation login, a secondary login prompt is displayed, asking the user to re-enter his current network password. 4. A second operating system plugin program is launched, which monitors all user interface activity—keystrokes and pointer events representing user input, processes that are executed, and windows and data fields activated on the workstation's display(s). 5. The monitor plugin compares the values entered by the user into data fields to the login ID and password captured in step 2 or 3. Where a new match is found, identifying characteristics of the data field, such as window ID, window title, field ID, field name, field position within the window and process ID, are stored in a data file, an operating system configuration database, or some other database. 6. The monitor plugin compares the data fields displayed on the workstation to a list of already known data fields in storage. If a data field is displayed that matches one whose characteristics have already been captured in storage, the login ID or password that were intercepted in step 2 or step 3 are automatically inserted into that data field, as appropriate. The present invention provides a method for reduced signon, whereby the number of separate instances where a user must provide his own login credentials is reduced, possibly to a single set of ID/password per workstation login session. This method improves the level of service offered by an IT organization to its users, as it saves time and effort for those users.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

A method for reducing the number of times that a user must type his/her own login ID or password into various systems that require authentication is disclosed.

2. Background of the Invention

The present invention relates in general to processes used by computer systems to authenticate users, prior to offering duly authenticated users authorized access to access-controlled data of features. In particular, the invention relates to password-protected systems, and to limiting the nuisance experienced by users who must repeatedly sign into multiple, unrelated systems.

### OBJECTS AND ADVANTAGES

The present invention relates in general to a method for reducing the number of times that a user must sign into various systems, to authenticate himself/herself. The intention is to eliminate as many as possible, but possibly not all, of the login ID/password prompts that a user must fill in, subsequent to having already signed into the workstation operating system.

Other systems have been proposed, and in some cases commercialized, for achieving the same outcome as described in [1]—namely, reduced or single signon. The present invention improves on the deployment characteristics of past methods.

One drawback of past methods for reduced or single signon is their use of script programs to launch applications, fill in login ID and password fields, and complete the signon process.

Scripts are problematic because they are costly to develop and maintain, and can be fragile. For example, different scripts may be required for different types of workstations—with different operating systems, different versions of the same operating system, or different hardware (speed, display resolution, language settings, input devices, etc.). Different scripts are required for every application that may be launched, and in fact different scripts are often required for each version of each application that may be launched. The variety of scripts and circumstances under which they perform make them costly to develop and maintain. The fact that applications and workstations may change without notice thereby invalidating assumptions made by scriptwriters and make scripts fragile.

Another drawback of past methods for reduced or single signon is reliance on a credential database, which stores each user's ID and password to every system.

The credential database may present security problems, since a compromise of this database may compromise every user's password to every system.

Another problem with a credential database, where every user has a different password, and possibly a different ID, on every system, is that the user is unlikely to know his own passwords to most systems, and will be unable to sign into most systems without benefit of the single signon client software. For example, a user's mail password may be different from that user's primary Single-Signon (SSO) password, and be stored in the credential database. This user will be unable to access his own mailbox from a web browser, from outside the corporate network, since the SSO client will be unavailable at this location.

The credential database also creates an availability problem. In the event that the credential database becomes unavailable, due to malfunction, security incident or other failure, every user will be unable to sign into every system. This is an undesirable, catastrophic mode of failure that does not exist in the network infrastructure prior to deployment of the single signon product.

As a consequence of the above-mentioned problems, existing methods for reducing user signons to legacy applications (i.e., those that expose a user interface directly on workstations, rather than through a web browser) have not been widely adopted.

At the same time that “enterprise,” or “legacy” single signon systems have failed to take hold in the market, other password management systems, which aid users in maintaining a single, synchronized password across multiple systems on the same network, and which allow a user who forgot his/her password to authenticate in some other way, and repair the problem himself/herself, have been very successful.

Password synchronization systems, in particular, have proven to be inexpensive to acquire, reliable in operation and simple to manage.

While password synchronization systems do reduce the number of passwords that a given user must remember, they do not reduce the frequency with which a user must type his/her own credentials into various systems, to authenticate. In other words, password synchronization addresses the shortcomings of existing single signon systems, as described in [5] (there are no login scripts), [7] (there is no global password repository which might be compromised) and [9] (there is no single point of failure), but does not deliver the ultimate and desirable user experience, of typing only one password, rather than simply remembering only one password.

### SUMMARY

Preceding strategies for reduced or single signon across legacy, or enterprise applications (i.e., those applications accessed through means other than or additional to web browsers) have not worked well, as described in [10]. The desire of users to minimize the repetitive task of logging into applications nonetheless still remains, as described in [13].

The present invention is intended to take advantage of the cost-of-deployment, cost-of-operation, high availability and security advantages of a password synchronization system, while at the same time delivering the benefit of a reduced number of signons to users.

The present invention works by assuming that a password synchronization system has been successfully deployed, and is in operation, in a given organization's network. As a result, any given user has just one password, and very likely just one login ID, across a broad array of systems attached to that organization's network. In order to reduce the number of login IDs and passwords that a user in such an organization must type, the present invention proposes monitoring what IDs and passwords the user does type in to various applications, and “remembering” instances where the initial, or primary login ID and password were typed into a given application. When the same application runs again later, and presents the same login prompt(s), the client software provides those credentials that it acquired during the user's initial network login.

Advantages of this solution over traditional single signon systems include:
There is no central repository at all. All credentials are assumed to be the same. As a result, there is no repository for a security intruder to attack or compromise. There is also no single point of failure in the system.
There are no scripts used to launch applications. All configurations are automatic and strictly local to each workstation. As a result, script writing, testing and maintenance are eliminated.
Users know their own password to each system. As a result, they are able to access systems even when the reduced signon system is unavailable, or through access channels (e.g., web browser, Extranet, etc.) where deployment of the single signon/reduced signon system would be impossible or infeasible.

### DRAWINGS—FIGURES

FIG. 1 is a schematic illustrating a typical “transparent” password synchronization system. Some form of password synchronization system is prerequisite to this invention, and this is an example. In this example, password changes initiated by users on an existing system are automatically propagated, through a password synchronization system, to other systems where the same user has login accounts.

FIG. 2 is a schematic illustrating a typical “web-based” password synchronization system. Some form of password synchronization system is prerequisite to this invention, and this is an example. In this example, password changes initiated by users using a web browser, connected to a web application, are automatically distributed, through a password synchronization system, to multiple systems where the same user has login accounts.

In FIG. 3, is a schematic illustrating the components of this solution that operate within a user's workstation:
A monitor plugin, attached to the workstation operating system, captures the login ID and password that the user typed to sign into the workstation. These credentials are subsequently made available to the event monitor.
An event monitor plugin, also attached to the workstation operating system, captures events sent between workstation operating system components, to display windows, display data fields in those windows, populate keystrokes into data fields, etc. This plugin identifies instances where the user types his/her login ID and password, and when it sees such a window again, automatically populates the current login ID and password, acquired from the first monitor plugin program.
Current credentials, captured by the first plugin program, are stored only for the duration of the user's workstation login session, in volatile memory.
The identity (and characteristics) of data fields where the user had typed his login ID or password in the past are stored in permanent storage—for example on the workstation's disk, on a solid state storage device, on the network, in a database, etc.

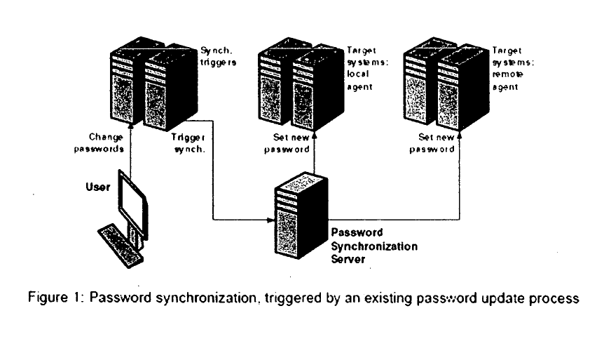

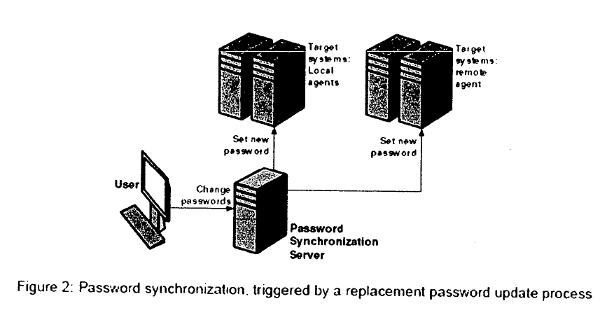

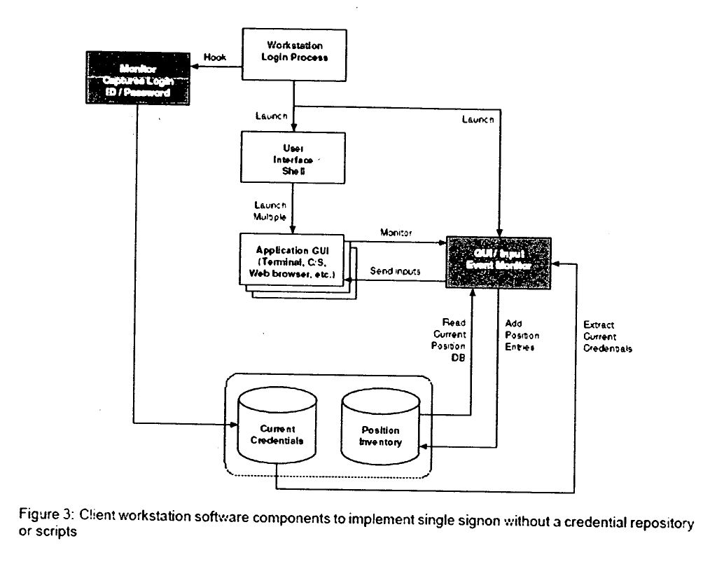

### DETAILED DESCRIPTION—FIGS. 1, 2 AND 3

Definition. Managed System

A managed system may be a computer operating system, database or application where users access some features or data, and where user access must be controlled.

Definition: User

Users are people whose access to systems and identity information must be managed.

Definition: Authentication

Authentication is a process used by a system to uniquely identify a user. Most systems authenticate users by asking them to type a secret password. Other forms of authentication include:
Using hardware tokens.
Using a PKI certificate.
Using a smart card.
Providing a biometric sample (finger print, voice print, etc.)
Answering personal questions.

Definition: Signon

The act of authentication is called a signon or sign-on. In the context of this document, a signon is generally understood to mean authentication using a login ID and secret password.

Definition: Reduced Signon

Reduced Signon is any technology which reduces the number of times that a user must type his/her own ID and password to access multiple, unrelated, un-integrated, password-protected systems.

Definition: Single Signon

Single Signon is reduced signon where the actual number of signons that a user must perform is reduced to just a single login ID and a single password. Reduced signon systems are often referred to as single signon systems. This is erroneous but is common usage.

Definition: Account

An account is the data used by a system to identify a single user, authenticate a user and control that user's access to resources.

Definition. Login ID

On most systems, accounts are uniquely identified by a short string of characters. This is called the Login ID, user ID or login name.

Definition: Credentials

A user's credentials to a system consist of a unique login ID and an authenticator. In most cases, the authenticator is a password.

Definition: Password synchronization

A password synchronization system is any software or process used to help users maintain a single password value on multiple password-protected systems.

Password synchronization may be optional or mandatory. Users may be encouraged to synchronize their passwords manually, or provided with an automated system for updating multiple passwords simultaneously.

Definition: Self-Service

Self-service is any process that allows a user to access a system function that would otherwise only be available to a system administrator or help desk analyst.

Definition: Password reset

A password reset is some process where a user who has either forgotten his own password, or triggered an intruder lockout on his own account can authenticate with something other than his password, and have a new password administratively set on his account.

Password resets may be performed by a help desk, or by self-service automation.

Definition: Self-Service Password Reset

A self-service password reset is a password reset ([57]) accomplished by interaction between the user and automated software (a web site, IVR system or other facility).

The invention described here is a process to reduce the number of times that a user must type his login ID and password to sign into multiple systems, after having already signed into a password-protected workstation.

The process works in conjunction with a password synchronization system, which maintains a consistent password for the user across multiple systems. Password synchronization is a well-understood and widely deployed technology, and is not discussed here in detail except for pointing out that it is a prerequisite technology.

The process is implemented by a computer program performing the following steps:
1. A user signs into his workstation, using a standard login ID and current network password.
2. A plugin program, inserted into the workstation operating system's login subsystem, captures the user's login ID and password.
3. In environments where this is either not technically possible or where insertion of such a plugin program is infeasible, once the user has completed the initial workstation login, a secondary login prompt is displayed, asking the user to re-enter his current network password.
4. A second operating system plugin program is launched, which monitors all user interface activity—keystrokes and pointer events representing user input, processes which are executed, and windows and data fields activated on the workstation's display(s).
5. The monitor plugin compares the values entered by the user into data fields to the login ID and password captured in step 2 or 3. Where a new match is found, identifying characteristics of the data field, such as window ID, window title, field ID, field name, field position within the window and process ID, are stored in a data file, an operating system configuration database, or some other database.
6. The monitor plugin compares the data fields displayed on the workstation to a list of already-known data fields in storage. If a data field is displayed that matches one whose characteristics have already been captured in storage, the login ID or password that were intercepted in step 2 or step 3 are automatically inserted into that data field, as appropriate.

This process has several advantages over other strategies that have been used in the past to minimize the number of repetitive signons by a user:
There is no central repository at all. All credentials are assumed to be the same. As a result, there is no repository for a security intruder to attack or compromise. There is also no single point of failure in the system.
There are no scripts used to launch applications. All configurations are automatic and strictly local to each workstation. As a result, script writing, testing and maintenance are eliminated.
Users know their own password to each system. As a result, they are able to access systems even when the reduced signon system is unavailable, or through access channels (e.g., web browser, Extranet, etc.) where deployment of the single signon/reduced signon system would be impossible or infeasible.

### CONCLUSION, RAMIFICATIONS, AND SCOPE

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

I claim:

1. A method for reducing the number of times that a user must sign into separate systems and applications, possibly to just once per workstation login session, comprising the steps of:
(a) A user signs into his workstation, using a standard login ID and current network password.
(b) A plugin program, inserted into the workstation operating system's login subsystem, captures the user's login ID and password.
(c) In environments where this is either not technically possible or where insertion of such a plugin program is infeasible, once the user has completed the initial workstation login, a secondary login prompt is displayed, asking the user to re-enter his current network password.
(d) A second operating system plugin program is launched, which monitors all user interface activity—keystrokes and pointer events representing user input, processes which are executed, and windows and data fields activated on the workstation's display(s).
(e) The monitor plugin compares the values entered by the user into data fields to the login ID and password captured in step 1b or 1c. Where a new match is found, identifying characteristics of the data field, such as window ID, window title, field ID, field name, field position within the window and process ID are stored in a data file, an operating system configuration database, or another database.
(f) The monitor plugin compares the data fields displayed on the workstation to a list of already known data fields in storage. If a data field is displayed that matches one whose characteristics have already been captured in storage, the login ID or password that were intercepted in step 1b or step 1c are automatically inserted into that data field, as appropriate.

2. The method as set forth in claim 1, wherein at step 1a the existing login process and ID/password validation continue to be used, thereby minimizing the change experienced by the user.

3. The method as set forth in claim 1 wherein at step 1b most operating systems provide for some mechanism for a suitably authorized program or other representation of software code to intercept the native operating system's login process and to extract from that process the login ID and password typed by the user.

4. The method as set forth in claim 1, wherein if implementation of step 1b is not possible for any reason, step 1c can be implemented instead. In this case, rather than automatically capturing the login ID and password of the user, the login ID is extracted from the operating system (this is always possible), and the user is simply asked to type his own password again. In this case, a user signs in with a single login ID and the same password twice, rather than a single login ID and a single password.

5. The method as set forth in claim 1, wherein at step 1d, some permanent representation of known login ID and password field(s) is maintained in between login sessions. This might be on a disk, a permanent memory device, locally on the workstation or on network-attached storage, but in any case is persistent between login sessions.

6. The method as set forth in claim 1, wherein at step 1d, the previous state of the permanent storage, hereinafter referred to as the database, is retrieved and made available for use in steps 1e and 1f, to determine whether or not a given input field displayed by the workstation is new or already described in the database.

7. The method as set forth in claim 1, wherein at step 1d a plugin program, or “hook” is inserted into the input and output processing subsystems of the operating system, by a suitably authorized program or process, so that it might monitor all input and output events on the system.

8. The method as set forth in claim 1, wherein at step 1e, each data field displayed on the workstation is compared against all already-known data fields in the database. Matches between data fields displayed on the workstation and already-known data fields in the database are handled in step 1f. The data keyed into fields that are not already known is compared to the login ID and password captured in steps 1b or 1c. Where there is a match, the database is updated in step 1e with a new field, for future reference.

9. The method as set forth in claim 1, wherein at step 1f, if a match is found between an already-known field in the database and a displayed field on the workstation, then the field is automatically populated with the login ID or password that were captured in steps 1b or 1c, as appropriate.

10. The method as set forth in claim 1, wherein at steps 1e and 1f, displayed data fields may be uniquely identified by a variety of characteristics, including the name or ID of the executing process that caused them to be displayed, the name, size, ID or position of the window in which they appear, or the name, ID, size or position of the field itself.
